(19) United States
(12) Patent Application Publication
(10) Pub. No.: US 2001/0041606 A1
(43) Pub. Date: Nov. 15, 2001

(54) Radio communication apparatus and method of controlling the radio communication apparatus

(75) Inventors: Ippo Aoki, Fuchu-shi (JP); Akira Ishikura, Kawasaki-shi (JP); Naoki Kaji, Hino-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 09/746,769

(22) Filed: Dec. 26, 2000

(30) Foreign Application Priority Data
Dec. 27, 1999 (JP) 11-370367

(51) Int. Cl. H04B 1/38

(52) U.S. Cl. 455/575; 455/566

(57) ABSTRACT

When a predetermined instruction is input by a user through a key input section, a microprocessor detects the input of the predetermined instruction. The microprocessor then renders personal digital assistant (PDA) functions available, turns off an RF switch, and stops power supply to a transmission system of an RF section. Further, the microprocessor controls an LED and/or a sounder to indicate that radio waves are not sent out to the outside.

### CROSS-REFERENCE TO RELATED APPLICATIONS

This application is based upon and claims the benefit of priority from the prior Japanese Patent Application No. 11-370367, filed Dec. 27, 1999, the entire contents of which are incorporated herein by reference.

### BACKGROUND OF THE INVENTION

The present invention relates generally to a radio communication apparatus having information processing means with functions of, e.g. a personal digital assistant (PDA), which can be used without radio signal transmission with the outside, and to a method of controlling the radio communication apparatus. More particularly, this invention relates to a radio communication apparatus permitting independent use of the information processing means even at a location or in a space where the use of the radio communication apparatus is limited, and to a method of controlling the radio communication apparatus.

Radio communication apparatuses such as mobile phones have various functions in addition to their phone functions. These radio communication apparatuses have the following functions, for instance:

1) A clock function for displaying time,

2) A scheduler function for managing schedules,

3) A telephone directory function for storing and editing telephone numbers, etc., and

4) A mailer function for controlling transmission/reception of e-mails, supporting preparation of e-mails, storing received e-mails, and enabling users to read e-mails.

There is known a radio communication apparatus with personal digital assistant (PDA) functions in which the clock function, scheduler function, telephone directory function and mailer function are integrated.

The use of the radio communication apparatus is limited or prohibited in hospitals, airplanes, trains, etc., because

1) Radio signals (waves) transmitted/received with the outside may affect the operations of devices nearby, and

2) Voice in calls may disturb persons nearby.

However, there are some functions requiring no radio wave transmission/reception with the outside, or some functions requiring no production of voice, among the integrated PDA functions including the clock function, scheduler function, telephone directory function and mailer function of the radio communication apparatus.

When the conventional radio communication apparatus is switched on, the apparatus is set in the standby mode and radio waves are transmitted/received with the radio base station to register the position of the radio communication apparatus. Even after it, radio waves are periodically transmitted/received with the radio base station to establish synchronism with the radio base station and to stand by for transmission/reception of calls.

Thus, the switching on of the radio communication apparatus automatically starts transmission/reception of radio waves with the outside, and the transmitted/received radio signals (radio waves) may affect the operations of devices nearby. Even the switching on of the radio communication apparatus is prohibited at such places or spaces as the insides of hospitals, airplanes, etc.

As has been described above, in the conventional radio communication apparatus, the switching on of the apparatus automatically starts radio wave transmission/reception with the outside. Thus, even switching on of the apparatus cannot easily be made at places or spaces where the use of the radio communication apparatus is limited or prohibited.

For example, a user who usually enjoys the clock function of the radio communication apparatus, without wearing a wristwatch, cannot make use of the clock function at places or spaces where the use of the radio communication apparatus is limited or prohibited.

A user who usually manages his/her schedules by means of the scheduler function cannot enjoy it at places or spaces where the use of the radio communication apparatus is limited or prohibited, even if he/she has no intention of making phone calls.

There is a case where a user wishes to find the telephone number of a party to be called by using the telephone directory function of the radio communication apparatus in order to make a call from a wired pay telephone, and not from the radio communication apparatus. In such a case, the user is not permitted to do so at places or spaces where the use of the radio communication apparatus is limited or prohibited or the switching on of the radio communication apparatus is prohibited.

Furthermore, even where a user wishes to enjoy the mailer function to read a stored e-mail once again, he/she is not permitted to do so at places or spaces where the use of the radio communication apparatus is limited or prohibited or the switching on of the radio communication apparatus is prohibited.

### BRIEF SUMMARY OF THE INVENTION

The object of the present invention is to provide a radio communication apparatus capable of rendering various information processing functions available without emitting radio signals at places or spaces where the use of radio communication is restricted, and also a method of controlling the radio communication apparatus.

In order to achieve the object, the present invention provides a radio communication apparatus comprising: radio communication means for effecting radio communication by transmitting/receiving a radio signal; information processing means for performing at least storage and display of information; input means for receiving an instruction from a user; and control means for disabling transmission of the radio signal from the radio communication means while keeping the information processing means operable, in accordance with presence/absence of the instruction from the user through the input means.

To achieve the object, the invention also provides a method of controlling a radio communication apparatus, the method comprising: a radio communication step of effecting radio communication by transmitting/receiving a radio signal; an information processing step of performing at least storage and display of information; an input step of receiving an instruction from a user; and a control step of disabling transmission of the radio signal in the radio communication step while enabling processing in the information processing step, in accordance with presence/absence of the instruction from the user received in the input step.

In these radio communication apparatus and control method, the control means disables transmission of the radio signal from the radio communication means while keeping the information processing means operable, in accordance with presence/absence of the instruction from the user through the input means.

According to the radio communication apparatus and control method, various information processing functions can be rendered available without emitting radio signals at places or spaces where the use of radio communication is restricted.

In the radio communication apparatus according to the invention, when a predetermined instruction from the user has been accepted through the input means within a predetermined time period from switch-on of the apparatus, the control means keeps the information processing means operable and disables the transmission of the radio signal by the radio communication means, and when the predetermined instruction from the user has not been accepted through the input means within the predetermined time period, the control means enables the transmission of the radio signal by the radio communication means.

In this radio communication apparatus, even if the apparatus is switched on, the radio signal cannot immediately be transmitted. If a predetermined instruction from the user has been accepted through the input means within a predetermined time period from switch-on of the apparatus, the control means keeps the information processing means operable and disables the transmission of the radio signal by the radio communication means.

According to this radio communication apparatus, if a predetermined instruction is input through the input means within the predetermined time period after switch-on of the apparatus, various information processing functions can be rendered available without emitting radio signals at places or spaces where the use of radio communication is restricted.

In addition, in the radio communication apparatus according to the invention, the control means renders the information processing means operable after switch-on of the apparatus, and if a predetermined instruction from the user has been accepted thereafter through the input means, the control means enables the transmission of the radio signal by the radio communication means.

In this radio communication apparatus, even if the apparatus is switched on, the radio signal cannot immediately be transmitted. Only when a predetermined instruction is input by the user through the input means, will the control means enable the transmission of the radio signal by the radio communication means.

According to this radio communication apparatus, once the apparatus is switched on, unless a predetermined instruction is input by the user, various information processing functions can be rendered available without emitting radio signals at places or spaces where the use of radio communication is restricted.

The radio communication apparatus according to the invention may further comprise alarm means for indicating that the information processing means is operable and the transmission of the radio signal by the radio communication means is disabled.

In this radio communication apparatus, it is possible to indicate that the transmission of the radio signal by the radio communication means is disabled, even where the apparatus is switched on and the information processing means is rendered operable.

According to this radio communication apparatus, it is indicated that the transmission of the radio signal by the radio communication means is disabled. Therefore, the user can easily switch on the apparatus and use the functions of the information processing means without worrying about other people at places or spaces where the use of the mobile phone is limited or prohibited.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram schematically showing the structure of a mobile phone 100 to which a radio communication apparatus and a control method therefor according to the present invention are applied;

FIG. 2 is a flow chart illustrating a control process for the mobile phone 100 shown in FIG. 1 according to a first embodiment of the invention;

FIG. 3 is a flow chart illustrating a control process for the mobile phone 100 shown in FIG. 1 according to a second embodiment of the invention;

FIG. 4 is a flow chart illustrating a control process for the mobile phone 100 shown in FIG. 1 according to a third embodiment of the invention;

FIGS. 5A, 5B, 5C and 5D show examples of display on a display unit 14 and an example of an alarm to the outside in the second embodiment shown in FIG. 3; and

FIGS. 6A, 6B, 6C and 6D show examples of display on the display unit 14 and an example of an alarm to the outside in the third embodiment shown in FIG. 4.

### DETAILED DESCRIPTION OF THE INVENTION

Embodiments of a radio communication apparatus and a control method therefor according to the present invention will now be described with reference to the accompanying drawings.

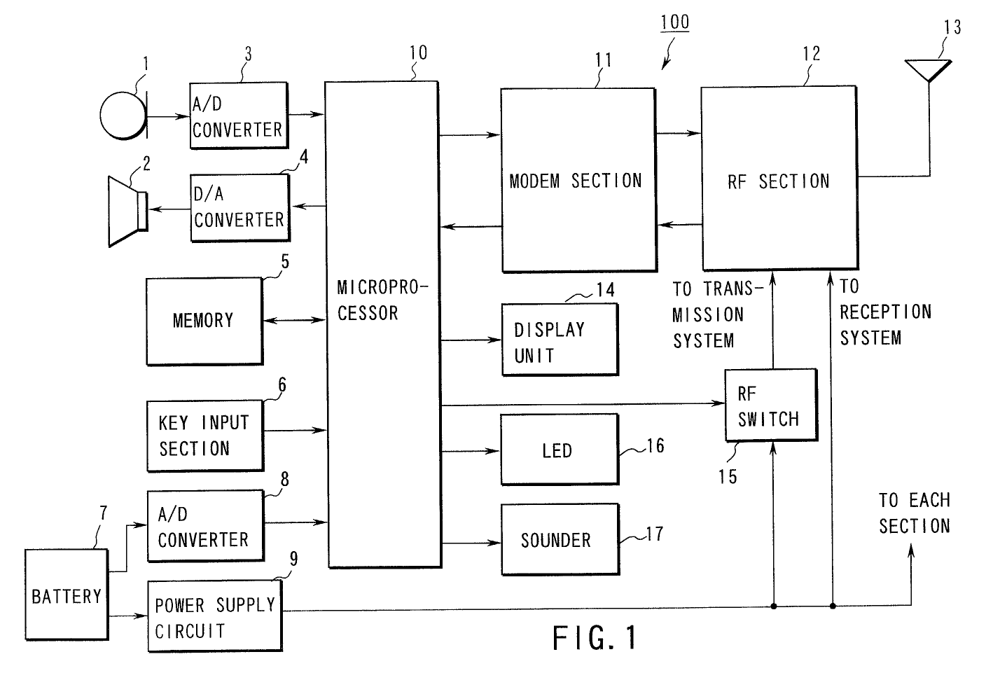

FIG. 1 is a block diagram schematically showing the structure of a mobile phone 100 to which the radio communication apparatus and control method therefor according to the present invention are applied.

In FIG. 1, the mobile phone 100 comprises a microphone 1, a loudspeaker 2, an analog-to-digital converter (A/D converter) 3, a digital-to-analog converter (D/A converter) 4, a memory 5, a key input section 6, a battery 7, an A/D converter 8, a power supply circuit 9, a microprocessor 10, a modem section 11, a radio-frequency wave section (RF section) 12, an antenna 13, a display unit 14, an RF switch 15, a light-emitting diode (LED) 16, and a sounder 17.

The microphone 1 constitutes a transmitter of the mobile phone 100. The loudspeaker 2 constitutes a receiver of the mobile phone 100. Voice input to the microphone 1 is converted to a speech signal in the microphone 1. The speech signal is converted to a digital signal by the A/D converter 3. The digital signal is input to the microprocessor 10. On the other hand, a reception speech signal output from the microprocessor 10 is converted to an analog signal by the D/A converter 4. The analog signal is supplied to the loudspeaker 2 and is output as voice.

The memory 5 stores various information relating to the mobile phone 100 as well as control programs for the microprocessor 10.

The key input section 6 includes dial keys and various function keys. The PWR key and FUNC key are included in the keys of the key input section 6.

The battery 7 comprises a rechargeable secondary battery. An output from the battery 7 is converted to a digital output by the A/D converter 8, and it is supplied to the microprocessor 10. In addition, the output from the battery 7 is delivered to the power supply circuit 9, and the power supply circuit 9 supplies power to the respective sections of the mobile phone 100.

The microprocessor 10 controls the entirety of the operations of the mobile phone 100. Personal digital assistant (PDA) functions according to embodiments of the invention are controlled by the microprocessor 10.

The modem section 11 modulates transmission signals and demodulates reception signals. A transmission signal from the microprocessor 10 is modulated by the modem section 11. The modulated signal is delivered to the RF section 12. An output from the RF section 12 is output as a transmission radio wave via the antenna 13.

A reception radio wave is received by the antenna 13 and input to the modem section 11 via the RF section 12. The modem section 11 demodulates the reception radio wave and delivers the demodulated radio wave to the microprocessor 10 as a reception signal.

The RF section 12 has a radio signal transmission function for converting the transmission signal from the modem section 11 to a radio signal of a specified radio channel of a radio base station (“up-conversion”), amplifying the converted radio signal, and feeding the amplified radio signal to the antenna 13. The RF section 12 also has a radio signal reception function for amplifying the reception radio signal from the antenna 13, converting the amplified radio signal to a base-band signal (“down-conversion”), and feeding the base-band signal to the modem section 11.

The display unit 14 comprises, for example, a liquid crystal display (LCD) and displays various information of the mobile phone 100.

The RF switch 15 turns on/off power to the transmission system of the RF section 12. The RF switch 15 is turned on/off by a control signal from the microprocessor 10. If the RF switch 15 is turned on, the radio signal transmission function of the RF section 12 is enabled, and transmission of a radio wave corresponding to a transmission signal to be sent out from the antenna 13 is permitted. Power is always supplied to the reception system of the RF section 12.

If the RF switch 15 is turned off, power to the transmission system of the RF section 12 is stopped and the radio signal transmission function of the RF section 12 is disabled. In short, transmission of a radio wave from the antenna 13 is prohibited.

The LED 16 visually indicates, by lighting or flickering, the state in which the radio signal transmission by the RF section 12 is disabled. On the other hand, the sounder 17 sends out a predetermined sound and aurally indicates the state in which the radio signal transmission by the RF section 12 is disabled.

With the above structure, voice input from the microphone 1 is converted to a digital signal by the A/D converter 3. The digital signal is delivered to the microprocessor 10 and then sent out to the radio base station via the modem section 11, RF section 12 and antenna 13.

On the other hand, a reception signal from the antenna 13 is delivered to the loudspeaker 2 via the RF section 12, modem section 11, microprocessor 10 and D/A converter 4, and the reception signal is output as voice.

The mobile phone 100 shown in FIG. 1 has personal digital assistant (PDA) functions as means available without transmission of radio signals.

The PDA functions include:

1) A scheduler function for managing schedules,

2) A telephone directory function for storing and managing telephone numbers, shortcut telephone numbers, etc., and

3) A mailer function for controlling transmission/reception of e-mails, supporting preparation of e-mails, storing received e-mails, and enabling users to read e-mails.

In this mobile phone 100, when the operation mode is switched to the PDA function mode in which the PDA functions are independently executed, the microprocessor 10 turns off the RF switch 15, thereby disabling transmission of radio waves via the antenna 13.

If the PWR key and FUNC key of the key input section 6 have been simultaneously depressed immediately after switch-on of the mobile phone 100 or in the standby mode, the operation mode is switched to the PDA function mode. If the PWR key of the key input section is depressed in the PDA function mode, the PDA function mode is restored to the standby mode.

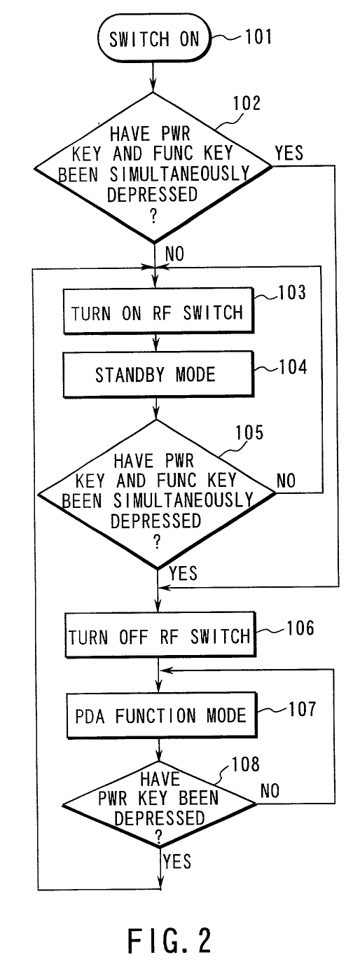

FIG. 2 is a flow chart illustrating a control process for the mobile phone 100 shown in FIG. 1 according to a first embodiment of the invention.

In FIG. 2, if the mobile phone 100 is switched on (step 101), it is determined whether the PWR key and FUNC key in the key input section 6 have been simultaneously depressed within a predetermined time period (step 102).

If the simultaneous depression of the PWR key and FUNC key is not detected within the predetermined time period (“NO” in step 102), the RF switch 15 is turned on (step 103) and the mobile phone 100 is set in the standby mode (step 104).

In the standby mode, it is determined whether the PWR key and FUNC key have been simultaneously depressed within a predetermined time period (step 105). If the simultaneous depression of the PWR key and FUNC key is not detected within the predetermined time period (“NO” in step 105), control returns to step 103 and the standby mode is continued. If the simultaneous depression of the PWR key and FUNC key is detected within the predetermined time period (“YES” in step 105), the RF switch 15 is turned off (step 106) and the mobile phone 100 is set in the PDA function mode (step 107).

On the other hand, if the simultaneous depression of the PWR key and FUNC key is detected within the predetermined time period in step 102 (“YES” in step 102), the RF switch 15 is immediately turned off (step 106) and the mobile phone 100 is set in the PDA function mode (step 107).

In the PDA function mode, it is determined whether the PWR key of the key input section 6 is depressed within a predetermined time period (step 108). If the depression of the PWR key is not detected within the predetermined time period (“NO” in step 108), control returns to step 107 and the PDA function mode is continued. If the depression of the PWR key is detected within the predetermined time period (“YES” in step 108), control returns to step 103, the RF switch 15 is turned on and the PDA function mode is restored to the standby mode (step 104).

In the first embodiment, even if the mobile phone 100 is switched on, it is not immediately set in the standby mode. The mobile phone 100 is set in the standby mode or in the PDA function mode, depending on whether the PWR key and FUNC key have been depressed within the predetermined time period. If the simultaneous depression of the PWR key and FUNC key is detected within the predetermined time period, the mobile phone 100 is set in the PDA function mode while the transmission system of the RF section 12 is in the off-state. In addition, if the simultaneous depression of the PWR key and FUNC key is detected within the predetermined time period in the standby mode, the transmission system of the RF section 12 is turned off and the mobile phone 100 is set in the PDA function mode. By virtue of this structure, the mobile phone 100 can be used as the PDA without emitting radio waves to the outside.

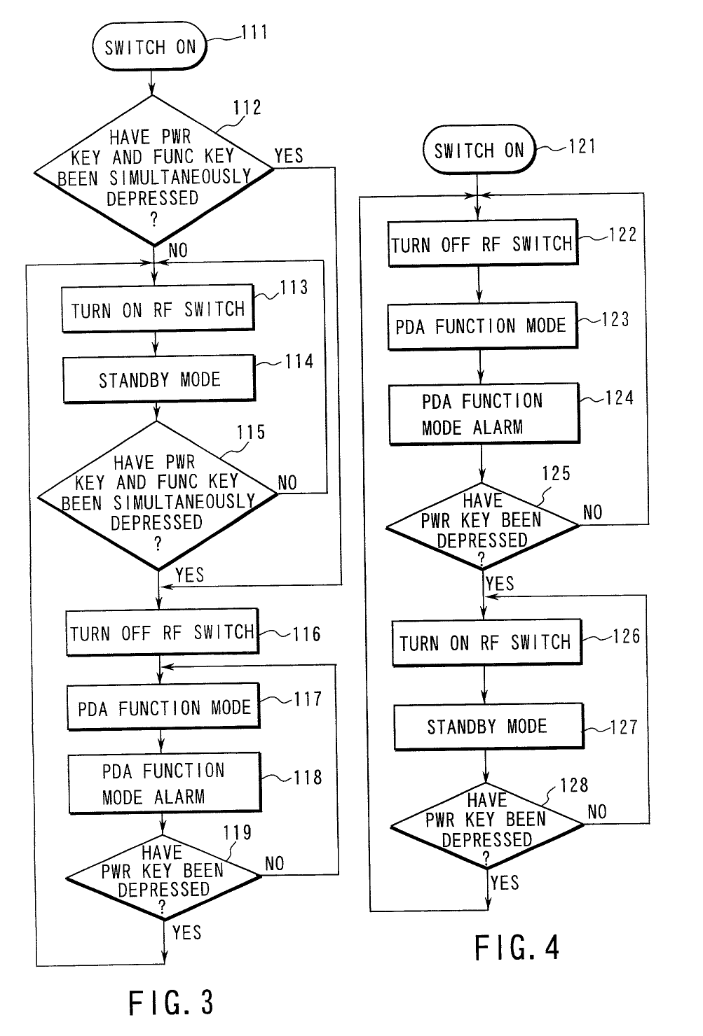

FIG. 3 is a flow chart illustrating a control process for the mobile phone 100 shown in FIG. 1 according to a second embodiment of the invention.

In the first embodiment, even if the mobile phone 100 is switched on, it is not immediately set in the standby mode. The mobile phone 100 is set in the standby mode or in the PDA function mode, depending on whether the PWR key and FUNC key have been depressed within the predetermined time period. Thus, the mobile phone 100 can be used as the PDA without emitting radio waves to the outside.

In the first embodiment, however, it is not possible to make persons near the user to recognize whether the mobile phone 100 is used in the state in which emission of radio waves to the outside is stopped. It is thus difficult to use the PDA functions, which are available without transmission/reception of radio signals with the outside, at places or spaces where the use of the mobile phone 100 is limited or prohibited.

In the second embodiment of the invention, the mobile phone 100 is constructed such that the use of the mobile phone 100 in the state in which emission of radio waves to the outside is stopped is positively indicated to the outside.

The control process of the flow chart in FIG. 3 is substantially the same as that of the flow chart of FIG. 2, except for the addition of step 118. In step 118, the setting of the PDA function mode, in which the mobile phone 100 is used while emission of radio waves to the outside is stopped, is positively indicated to the outside.

Specifically, in FIG. 3, if the mobile phone 100 is switched on (step 111), it is determined whether the PWR key and FUNC key in the key input section 6 have been simultaneously depressed within a predetermined time period (step 112). If the simultaneous depression of the PWR key and FUNC key is not detected within the predetermined time period (“NO” in step 112), the RF switch 15 is turned on (step 113) and the mobile phone 100 is set in the standby mode (step 114).

In the standby mode, it is determined whether the PWR key and FUNC key have been simultaneously depressed within a predetermined time period (step 115). If the simultaneous depression of the PWR key and FUNC key is not detected within the predetermined time period (“NO” in step 115), control returns to step 113 and the standby mode is continued. If the simultaneous depression of the PWR key and FUNC key is detected within the predetermined time period (“YES” in step 115), the RF switch 15 is turned off (step 116) and the mobile phone 100 is set in the PDA function mode (step 117).

On the other hand, if the simultaneous depression of the PWR key and FUNC key is detected within the predetermined time period in step 112 (“YES” in step 112), the RF switch 15 is immediately turned off (step 116) and the mobile phone 100 is set in the PDA function mode (step 117).

If the PDA function mode is initiated, a PDA function mode alarm is effected to indicate to the outside that the PDA function mode is being executed without emitting radio waves to the outside (step 118). The PDA function mode alarm is effected, for example, by the following methods:

1) Lighting or flickering the LED 16,

2) Sending out predetermined sound from the sounder 17, and/or

3) Altering the color of backlight of the display unit 14.

In the PDA function mode, it is determined whether the PWR key of the key input section 6 is depressed within a predetermined time period (step 119). If the depression of the PWR key is not detected within the predetermined time period (“NO” in step 119), control returns to step 107 and the PDA function mode is continued. If the depression of the PWR key is detected within the predetermined time period (“YES” in step 119), control returns to step 113, the RF switch 15 is turned on and the PDA function mode is restored to the standby mode (step 114).

By virtue of this structure, it is possible to positively indicate to persons near the user that the mobile phone 100 is being used as the PDA without emitting radio waves to the outside. Thereby, the user can easily use the PDA functions of the mobile phone without worrying about other people at places or spaces where the use of the mobile phone is limited or prohibited.

FIG. 4 is a flow chart illustrating a control process for the mobile phone 100 shown in FIG. 1 according to a third embodiment of the invention.

In the third embodiment, if the mobile phone 100 is switched on, the RF switch 15 is immediately turned off and the PDA function mode is initiated. In the PDA function mode, if the PWR key is depressed within a predetermined time period, the PDA function mode is changed to the standby mode.

Specifically, in FIG. 4, if the mobile phone 100 is switched on (step 121), the RF switch 15 is immediately turned off (step 122) and the PDA function mode is initiated (step 123). It is then indicated to persons near the user that the mobile phone 100 is being used as the PDA without emission of radio waves to the outside (step 124).

In brief, in the third embodiment, if the mobile phone is switched on, it is first activated in the PDA function mode.

In the PDA function mode, it is determined whether the PWR key is depressed within a predetermined time period (step 125). If the PWR key is not depressed within the predetermined time period (“NO” in step 125), control returns to step 122 and the PDA mode is continued.

If the PWR key has been depressed within the predetermined time period (“YES” in step 125), the RF switch is turned on (step 126) and the PDA function mode is switched to the standby mode (step 127).

In the standby mode, it is determined once again whether the PWR key is depressed within a predetermined time period (step 128). If the PWR key is not depressed within the predetermined time period (“NO” in step 128), control returns to step 126 and the standby mode is continued. If the PWR key has been depressed within the predetermined time period (“YES” in step 128), the RF switch is turned off (step 122) and the operation mode is restored to the PDA function mode (step 123).

As has been described above, in the third embodiment, if the mobile phone 100 is switched on, it functions as the PDA while the transmission system of the RF section 12 is kept in the off-state, and the use of the mobile phone 100 as the PDA is indicated to persons around the user.

According to this mobile phone, the operability of the mobile phone as the PDA is enhanced. When the mobile phone is used as the PDA, radio waves are not sent out. In addition, the use of the mobile phone as the PDA is positively indicated to persons around the user.

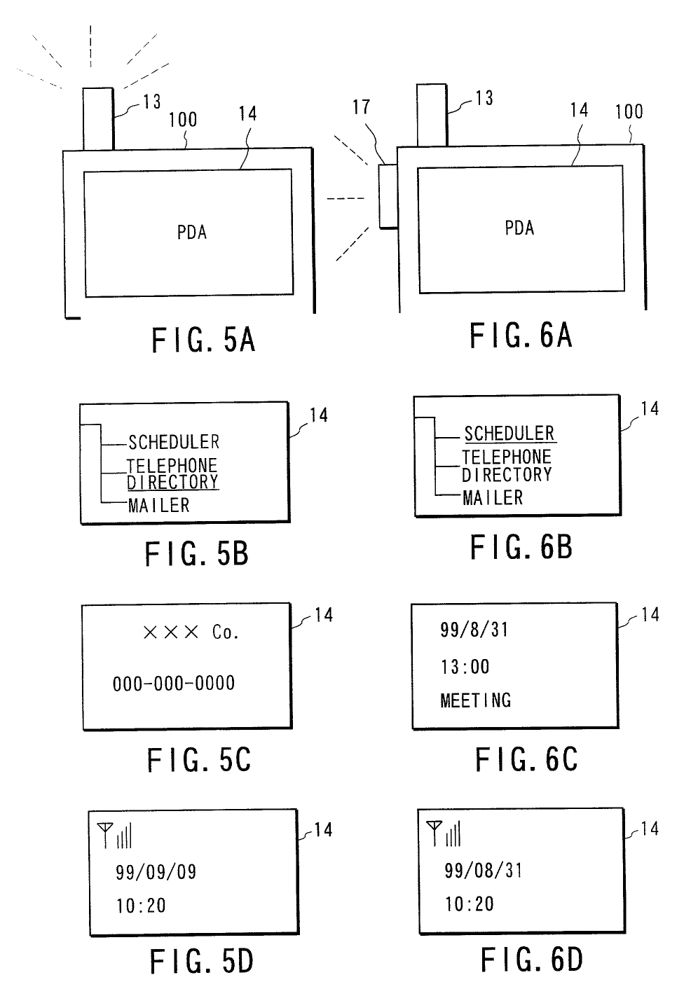

FIGS. 5A, 5B, 5C and 5D show examples of display on the display unit 14 and an example of an alarm to the outside in the second embodiment shown in FIG. 3.

In FIGS. 5A, 5B, 5C and 5D, the LED 16 shown in FIG. 1 is provided in the antenna 13. By lighting the LED 16, persons around the user are informed that the mobile phone 100 is being used as the PDA without emission of radio waves to the outside.

Specifically, when the mobile phone 100 is switched on (step 111 in FIG. 3) and the PWR key and FUNC key are simultaneously depressed within the predetermined time period (“YES” in step 112), the RF switch 15 is immediately turned off (step 116) and the PDA function mode is initiated (step 117).

Then, the LED 16 is lighted to inform persons around the user that the mobile phone 100 is being used as the PDA (FIG. 5A).

Subsequently, “TELEPHONE DIRECTORY” is chosen from the menu screen of the PDA (FIG. 5B) and a desired telephone number is displayed (FIG. 5C).

If the PWR key is depressed within the predetermined time period (“YES” in step 119 in FIG. 3), control returns to step 113, the RF switch 15 is turned on and the standby mode is initiated (step 114). Thus, the display image on the display unit 14 is changed to indicate the standby mode (FIG. 5D).

In the example shown in FIGS. 5A, 5B, 5C and 5D, when the mobile phone is used as the PDA, the LED 16 built in the antenna 13 is lighted to indicate to persons around the user that the mobile phone is being used as the PDA. Even at places where the use of the mobile phone is restricted, it is possible to use it as the PDA without worry.

In FIGS. 5A, 5B, 5C and 5D, the LED 16 is built in the antenna 13. However, the LED 16 may be disposed separately from the antenna 13.

FIGS. 6A, 6B, 6C and 6D show examples of display on the display unit 14 and an example of an alarm to the outside in the third embodiment shown in FIG. 4.

In the example of FIGS. 6A, 6B, 6C and 6D, predetermined sound is sent out from the sounder 17 to inform persons around the user that the mobile phone 100 is being used as the PDA without emission of radio waves to the outside.

Specifically, when the mobile phone 100 is switched on (step 121 in FIG. 4), the RF switch 15 is set in the off-state (step 122) and the PDA function mode is initiated (step 123).

Then, the sounder 17 is activated to sent out sound, thereby informing persons around the user that the mobile phone 100 is being used as the PDA (FIG. 6A).

Subsequently, “SCHEDULER” is chosen from the menu screen of the PDA (FIG. 6B) to activate the scheduler, and a desired schedule is displayed (FIG. 6C).

If the PWR key is depressed within the predetermined time period (“YES”in step 125 in FIG. 4), the RF switch 15 is turned on (step 126) and the standby mode is initiated (step 127). Thus, the display image on the display unit 14 is changed to indicate the standby mode (FIG. 6D).

In the example shown in FIGS. 6A, 6B, 6C and 6D, when the mobile phone is used as the PDA, the sounder 17 is activated to emit sound, thereby to indicate to persons around the user that the mobile phone is being used as the PDA. Even at places where the use of the mobile phone is restricted, it is possible to use it as the PDA without worry.

The methods of informing persons around the user that the mobile phone 100 is being used as the PDA without emission of radio waves to the outside are not limited to the use of the LED 16 and the use of the sounder 17. For example, where the display unit 14 shown in FIG. 1 is an LCD with backlight, the color of the backlight may be varied for this purpose.

For example, when the mobile phone 100 is used in the standby mode, white backlight of the display unit 14 may be used. When the mobile phone 100 is used in the PDA function mode without emission of radio waves to the outside, the white backlight may be changed to green backlight.

In the above-described embodiments, external emission of radio waves is stopped by controlling power supply to the transmission system of the RF section 12. Instead, external emission of radio waves may be stopped by cutting off a signal path of transmission radio signals.

Moreover, in the above-described embodiments, the transmission system alone of the RF section 12 is on/off controlled. However, the entirety of the RF section 12, i.e. both the transmission system and reception system, may be on/off controlled.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication apparatus comprising:
radio communication means for effecting radio communication by transmitting/receiving a radio signal;
information processing means for performing at least storage and display of information;
input means for receiving an instruction from a user; and
control means for disabling transmission of the radio signal from the radio communication means while keeping the information processing means operable, in accordance with presence/absence of the instruction from the user through the input means.

2. A radio communication apparatus according to claim 1, wherein when a predetermined instruction from the user has been accepted through the input means within a predetermined time period from switch-on of the apparatus, the control means keeps the information processing means operable and disables the transmission of the radio signal by the radio communication means, and when the predetermined instruction from the user has not been accepted through the input means within the predetermined time period, the control means enables the transmission of the radio signal by the radio communication means.

3. A radio communication apparatus according to claim 1, wherein the control means renders the information processing means operable after switch-on of the apparatus, and if a predetermined instruction from the user has been accepted thereafter through the input means, the control means enables the transmission of the radio signal by the radio communication means.

4. A radio communication apparatus according to claim 1, further comprising alarm means for indicating that the information processing means is operable and the transmission of the radio signal by the radio communication means is disabled.

5. A radio communication apparatus according to claim 1, wherein the information processing means has at least one of a clock function for measuring and displaying time, a scheduler function for storing schedules, a telephone directory function for storing telephone numbers, and a mailer function for storing and displaying a received e-mail.

6. A method of controlling a radio communication apparatus, the method comprising:
a radio communication step of effecting radio communication by transmitting/receiving a radio signal;
an information processing step of performing at least storage and display of information;
an input step of receiving an instruction from a user; and
a control step of disabling transmission of the radio signal in the radio communication step while enabling processing in the information processing step, in accordance with presence/absence of the instruction from the user received in the input step.
